(19) United States
(12) Patent Application Publication
(10) Pub. No.: US 2010/0296296 A1
(43) Pub. Date: Nov. 25, 2010

(54) HIGH CONTRAST LIGHT PATTERN PROJECTION MECHANISM

(75) Inventor: Ching-Cherng SUN, Jhongli City (TW)

Correspondence Address: Best International Patent & Trademark Office (USA), PO Box 220776, CHANTILLY, VA, 20153, US

(73) Assignee: National Central University

(21) Appl. No.: 12/845,525

(22) Filed: Jul. 28, 2010

Related U.S. Application Data
(63) Continuation-in-part of application No. 12/258,516, filed on Oct. 27, 2008.
Application No. 12/258,516 is a continuation-in-part of application No. 12/558,516, filed on Sep. 12, 2009.

(51) Int. Cl. F21V 7/00

(52) U.S. Cl. 362/297

(57) ABSTRACT

A high contrast light pattern projection mechanism includes a first reflecting body and a second reflecting body installed at upper and lower portions of an open end of a reflecting cavity respectively. If a light emitting module in the reflecting cavity emits a light source, a large-angle light and a small-angle light of the light source will be reflected from the first reflecting surface in the reflecting cavity and the second and third reflecting surfaces of the reflecting bodies respectively, such that the large-angle light and the small-angle light form a high contrast light pattern to be emitted to the outside, so as to enhance both contrast and illumination efficiency of the projection mechanism.

### CROSS-REFERENCES TO RELATED APPLICATIONS

This application is a continuation-in-part of the copending application Ser. No. 12/558,516 filed Sep. 12, 2009.

### BACKGROUND OF THE INVENTION

1. Field of the Invention

The present invention relates to a high contrast light pattern projection mechanism, in particular to a technology capable of enhancing both contrast and illumination efficiency of light patterns emitted by the projection mechanism.

2. Description of Related Art

At present, a light source for illuminating the front of a motor vehicle is generally provided by headlights installed on both sides of the front of the motor vehicle, such that road conditions in front of the motor vehicle can be illuminated, and the lights also alert and remind drivers of cars coming in the opposite direction to drive more carefully. If the headlights installed on both sides are too strong such as a high beam, the road conditions at the front of the motor vehicle can be illuminated clearly, but the high beam also affects the vision of the drivers of the opposite approaching cars, such that the vision of the drivers of the opposite coming cars is affected by a sudden strong light, which may cause a serious driving safety problem. If the headlights are too weak such as a low beam, then the road conditions at the front of motor vehicle cannot be illuminated clearly, and the drivers of the opposite approaching cars will not know that there is a car coming, or the drivers of the opposite approaching cars will not be alerted to drive more carefully.

To allow the light source of the headlights of a motor vehicle to be projected onto the road in the front only and prevent a portion of the light source from projecting into the eyes of drivers of the cars coming in the opposite direction, a traditional automobile lamp generally includes a louver installed at the front of the light bulb of the automobile lamp to block a certain portion of the front of the light bulb, such that the light source at the front of the light bulb cannot be emitted to the outside, but only the light source at upper and lower portion of the light bulb can be reflected to the outside through a reflecting cavity. The light source can be used for illuminating a road at the front of the motor vehicle without affecting the vision of the drivers of the opposite approaching cars. Alternatively, an opaque paint is coated onto an internal side of a glass at the front of the light bulb, and a semicircular louver is installed at the lower portion of an opening at the front end of the reflecting cavity, such that the light source at the lower portion of the light bulb reflected from the reflecting cavity is blocked by the louver, and the light source will not be illuminated upward to affect the vision of drivers of the opposite approaching cars, but the light source will illuminate the road surface only. However, such design reduces the contrast of the light source of the automobile lamps and the efficiency of illuminating the road surface significantly.

Therefore, the aforementioned structure of the traditional automobile lamps still has drawbacks, and it is an important subject for the present invention to provide a better high contrast light pattern projection mechanism to enhance the illumination efficiency and the contrast of the light source of the automobile lamps.

### SUMMARY OF THE INVENTION

Therefore, it is a primary objective of the present invention to provide a high contrast light pattern projection mechanism, comprising a light emitting module for emitting a light source, such that a large-angle light and a small-angle light of the light source can be reflected from a first reflecting surface in a reflecting cavity, and a second reflecting surface and a third reflecting surface situated at upper and lower portions of an open end of the reflecting cavity respectively, such that the large-angle light and the small-angle light are emitted outside the projection mechanism to form a high contrast light pattern, so as to enhance both contrast and illumination efficiency of the projection mechanism.

### BRIEF DESCRIPTION OF THE DRAWINGS

The invention, as well as its many advantages, may be further understood by the following detailed description and drawings in which:

FIG. 1 is a cross-sectional view of a first preferred embodiment of the present invention;

FIG. 2 is a cross-sectional view of a second preferred embodiment of the present invention;

FIG. 3 is a cross-sectional view of a third preferred embodiment of the present invention; and

FIG. 4 is a cross-sectional view of a fourth preferred embodiment of the present invention.

### DETAILED DESCRIPTION OF THE INVENTION

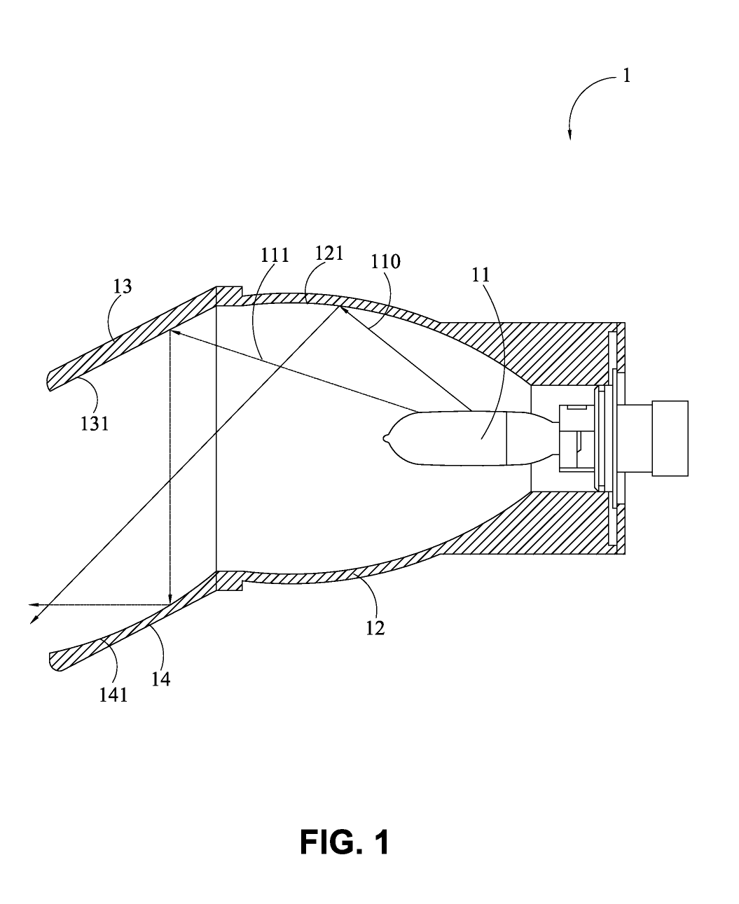

With reference to FIG. 1 for a cross-sectional view showing a high contrast light pattern projection mechanism 1 in accordance with a first preferred embodiment of the present invention, the projection mechanism 1 comprises a light emitting module 11, a reflecting cavity 12, a first reflecting body 13 and a second reflecting body 14, wherein the light emitting module 11 is provided for emitting a light source and installed in the reflecting cavity 12, and the reflecting cavity 12 includes a first reflecting surface 121.

The first reflecting body 13 and the second reflecting body 14 are installed at upper and lower portions of an open end of the reflecting cavity 12 respectively and a second reflecting surface 131 and a third reflecting surface 141 corresponding to the first reflecting surface 121 of the reflecting cavity 12. In this preferred embodiment, the first reflecting surface 121 is a parabolic surface, and the second reflecting surface 131 is a plane, and the third reflecting surface 141 is a one-dimensional extended curved surface of a parabola.

In this preferred embodiment, the projection mechanism 1 is applied to a motor vehicle (not shown in the figure). If the light emitting module 11 emits a light source by an internal power supply of the motor vehicle, a large-angle light 110 emitted by the light source will be reflected from the first reflecting surface 121, and projected directly onto a road surface (not shown in the figure), and a small-angle light 111 emitted by the light source will be refracted from the second reflecting surface 131 to the third reflecting surface 141, and then reflected to the road surface. Since the first reflecting surface 121 is a parabolic surface, and the second reflecting surface 131 is a plane, and the third reflecting surface 141 is a one-dimensional extended curved surface of a parabola, therefore the large-angle light 110 and the small-angle light 111 will form a high contrast light pattern.

In this preferred embodiment, the light emitting module 11 is a light bulb or an LED.

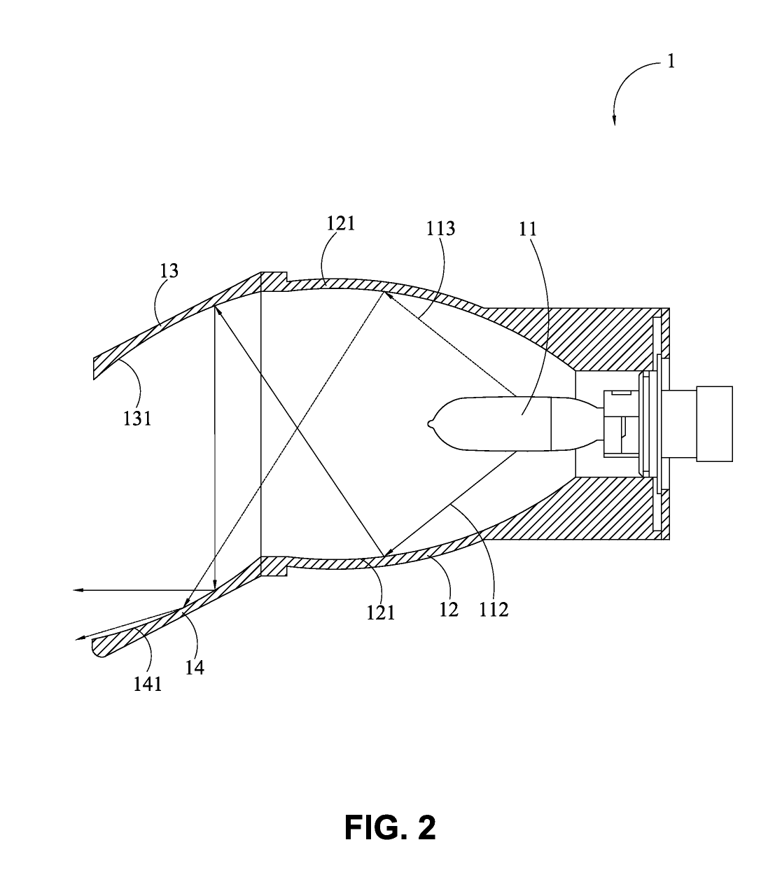

With reference to FIG. 2 for a high contrast light pattern projection mechanism 1 in accordance with a second preferred embodiment of the present invention, the projection mechanism 1 has substantially the same structure of the first preferred embodiment, and thus the structure will not be described again here, except that the first reflecting surface 121 of the second preferred embodiment is an elliptical surface, and the second reflecting surface 131 is a one-dimensional extended curved surface of an elliptical curve, and the third reflecting surface 141 is a one-dimensional extended curve of a parabola.

If the light emitting module 11 emits a light source by an internal power supply of the motor vehicle, a small-angle light 112 emitted from the light source will be reflected from a lower half portion of the first reflecting surface 121 to the second reflecting surface 131, and then reflected to the third reflecting surface 141, and finally reflected to form a high contrast light pattern, and a large-angle light 113 emitted from the light source is reflected from an upper half portion of the first reflecting surface 121 to the third reflecting surface 141, and then reflected to form a high contrast light pattern. Since the first reflecting surface 121 is an elliptical surface, and the second reflecting surface 131 is a one-dimensional extended curved surface of an elliptical curve, and the third reflecting surface 141 is a one-dimensional extended curved surface of a parabola, therefore the small-angle light 112 and the large-angle light 113 will form a high contrast light pattern.

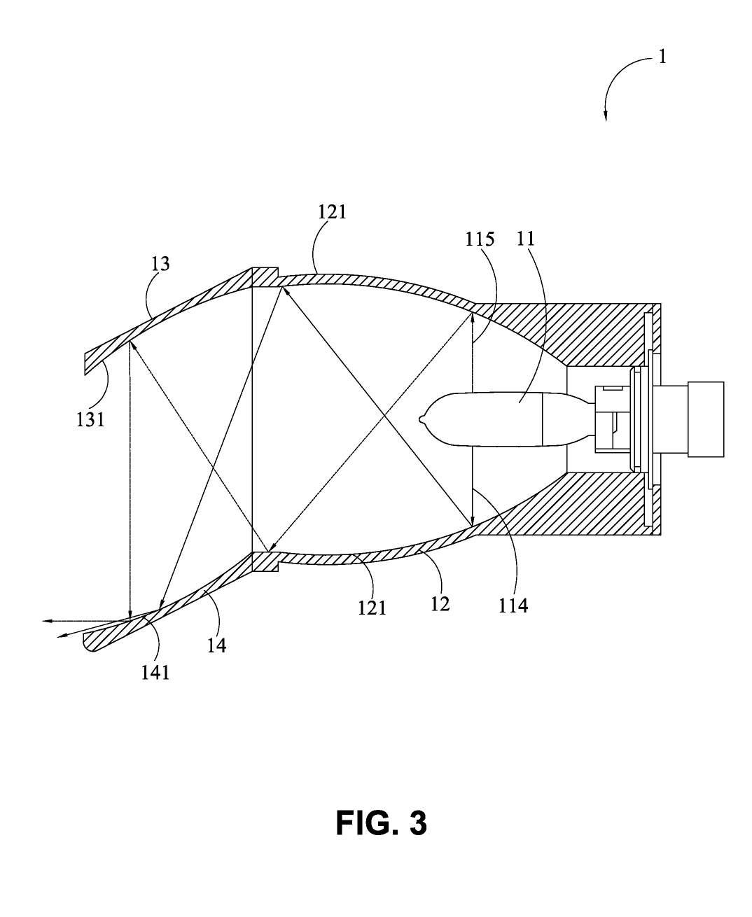

With reference to FIG. 3 for a cross-sectional view showing a high contrast light pattern projection mechanism 1 in accordance with a third preferred embodiment of the present invention, the projection mechanism 1 has substantially the same structure of the first and second preferred embodiments, and thus the structure will not be described again, except that the first reflecting surface 121 of the third preferred embodiment is a parabolic surface or an elliptical surface, and the second reflecting surface 131 is an aspherical surface, and the third reflecting surface 141 is a one-dimensional extended curved surface of a parabola.

If the light emitting module 11 emits a light source by an internal power supply of the motor vehicle, a small-angle light 114 emitted by the light source will be reflected from a lower half portion of the first reflecting surface 121 to the first reflecting surface 121, and then reflected to the third reflecting surface 141, and finally reflected to form a high contrast light pattern, and a large-angle light 115 emitted by the light source will be reflected from the upper half portion of the first reflecting surface 121 to the lower half portion of the first reflecting surface 121, and reflected to the second reflecting surface 131, and then reflected to the third reflecting surface 141, and finally reflected to form a high contrast light pattern. Since the first reflecting surface 121 is a parabolic surface or an elliptical surface, and the second reflecting surface 131 is an spherical surface, and the third reflecting surface 141 is a one-dimensional extended curved surface of a parabola, therefore the small-angle light 114 and the large-angle light 115 will form a high contrast light pattern.

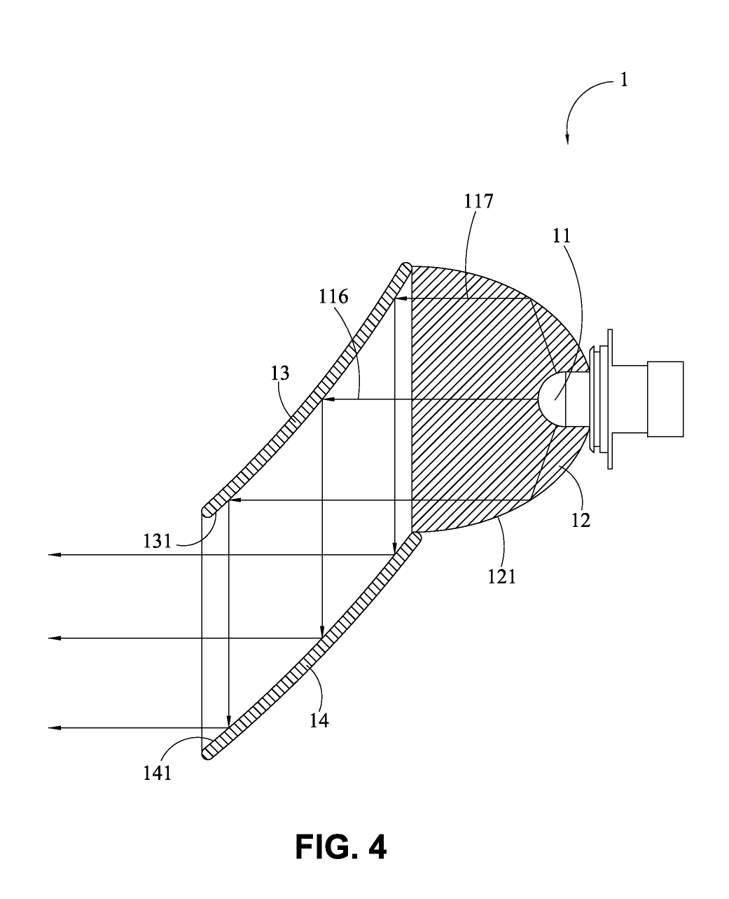

With reference to FIG. 4 for a cross-sectional view showing a high contrast light pattern projection mechanism 1 in accordance with a fourth preferred embodiment of the present invention, the reflecting cavity 12 is designed as a solid transparent lens, In this preferred embodiment, the first reflecting surface 121 is a parabolic surface or an elliptic surface, and the second reflecting surface 131 is a plane, a one-dimensional extended curved surface of an ellipse, a one-dimensional extended curved surface of a parabola, or an aspherical surface, and the third reflecting surface 141 is a plane, a one-dimensional extended curved surface of a parabola, a one-dimensional parabolic surface of an ellipse or an aspherical surface.

If the light emitting module 11 emits a light source through a power supply installed in a car, a small-angle light 116 emitted by the light source will be reflected from the first reflecting surface 121 of the reflecting cavity 12 of the solid transparent lens to the second reflecting surface 131, and reflected from the second reflecting surface 131 to the third reflecting surface 141, and reflected from the third reflecting surface 141 to form a high contrast light pattern, and a large-angle light 117 emitted by the light source is reflected from an upper half portion of the first reflecting surface 121 to the second reflecting surface 131, and reflected from the second reflecting surface 131 to the third reflecting surface 141, and reflected from the third reflecting surface 141 to form a high contrast light pattern, and the large-angle light 117 is reflected from a lower half portion of the first reflecting surface 121 to the second reflecting surface 131, and reflected from the second reflecting surface 131 to the third reflecting surface 141, and reflected from the third reflecting surface 141 to form a high contrast light pattern, such that the first reflecting surface 121 in the reflecting cavity 12 of the solid transparent lens reflects the light source emitted from the light emitting module 111 to the second reflecting surface 131 and the third reflecting surface 141, and then the second reflecting surface 131 and the third reflecting surface 141 are provided for reflecting the light source out of the reflecting cavity 12 to form the high contrast light pattern.

It is noteworthy to point out that when a light source is projected from the reflecting cavity 12 of the solid transparent lens, the edges of the reflecting cavity 12 will provide surfaces of a total reflection (or form the first reflecting surface 121), such that the traveling path of the large-angle light 117 passes from the light emitting module 11 to the second reflecting surface 131 of the reflecting body 13 through the first reflecting surface 121, and then reflects the light from the second reflecting surface 131 to the third reflecting surface 141 of the other reflecting body 14, and finally the large-angle light 117 is reflected from the third reflecting surface 141 and projected out of the high contrast light pattern projection mechanism 1 to form a high contrast light pattern.

In summation of the description above, the projection mechanism 1 of the present invention includes the first reflecting body 13 and the second reflecting body 14 installed at the upper and lower portions of the open end of the reflecting cavity 12 respectively, and the second reflecting surface 131 and the third reflecting surface 141 corresponding to the first reflecting surface of the reflecting cavity 12, so that the reflecting surfaces 121, 131, 141 are provided for forming a high contrast light pattern by the small-angle lights 111, 112, 114, 116 and the large-angle lights 110, 113, 115, 117 emitted by the light emitting module 11 inside the reflecting cavity 12 to overcome the problems of a traditional automobile lamp having a significant drop of contrast and a large loss of illumination efficiency.

Many changes and modifications in the above described embodiment of the invention can, of course, be carried out without departing from the scope thereof Accordingly, to promote the progress in science and the useful arts, the invention is disclosed and is intended to be limited only by the scope of the appended claims.

What is claimed is:

1. A high contrast light pattern projection mechanism, comprising:
a reflecting cavity, including a first reflecting surface therein;
a first reflecting body, installed at an upper portion of an open end of the reflecting cavity, and including a second reflecting surface; and
a second reflecting body, installed at a lower portion of the open end of the reflecting cavity, and including a third reflecting surface;
a light emitting module, installed in the first reflecting surface of the reflecting cavity, for emitting a light source, such that the light source is reflected from the first reflecting surface, the second reflecting surface and the third reflecting surface and projected to the outside.

2. The high contrast light pattern projection mechanism of claim 1, wherein the first reflecting surface is disposed on an internal side of the reflecting cavity.

3. The high contrast light pattern projection mechanism of claim 2, wherein the first reflecting surface is one selected from the collection of a parabolic surface and an elliptical surface.

4. The high contrast light pattern projection mechanism of claim 3, wherein the second reflecting surface corresponds to the first reflecting surface.

5. The high contrast light pattern projection mechanism of claim 4, wherein the second reflecting surface is one selected from the collection of a plane, a one-dimensional extended curved surface of an elliptical curve, a one-dimensional extended curved surface of a parabola, and an spherical surface.

6. The high contrast light pattern projection mechanism of claim 3, wherein the third reflecting surface corresponds to the first reflecting surface.

7. The high contrast light pattern projection mechanism of claim 6, wherein the third reflecting surface is one selected from the collection of a plane, a one-dimensional extended curved surface of a parabola, a one-dimensional parabolic surface of an ellipse and an spherical surface.

8. The high contrast light pattern projection mechanism of claim 6, wherein the second reflecting surface corresponds to the third reflecting surface.

9. The high contrast light pattern projection mechanism of claim 1, wherein the light emitting module is selected from the collection of a light bulb and an LED.

10. The high contrast light pattern projection mechanism of claim 1, wherein the reflecting cavity is a solid transparent lens.

11. The high contrast light pattern projection mechanism of claim 10, wherein the reflecting body is installed at the top of a front end of the solid transparent lens.

12. The high contrast light pattern projection mechanism of claim 10, wherein the other reflecting body is installed at the bottom of a front end of the solid transparent lens.

13. The high contrast light pattern projection mechanism of claim 10, wherein the first reflecting surface is disposed on an internal side of the solid transparent lens.

14. The high contrast light pattern projection mechanism of claim 13, wherein the second reflecting surface corresponds to the first reflecting surface.

15. The high contrast light pattern projection mechanism of claim 14, wherein the third reflecting surface corresponds to the first reflecting surface.

16. The high contrast light pattern projection mechanism of claim 15, wherein the second reflecting surface corresponds to the third reflecting surface.
